(19) United States
(12) Patent Application Publication
(10) Pub. No.: US 2025/0012981 A1
(43) Pub. Date: Jan. 9, 2025

(54) ENERGY TRANSMITTING STUD-AND-SOCKET RELEASABLE FASTENING SYSTEM

(71) Applicant: Joseph A. Manly, Chelsea, MI (US)

(72) Inventor: Joseph A. Manly, Chelsea, MI (US)

(21) Appl. No.: 18/710,473

(22) PCT Filed: Nov. 23, 2022
(86) PCT No.: PCT/US22/80384

§ 371 Date: May 15, 2024

Related U.S. Application Data
(60) Provisional application No. 63/282,499, filed on Nov. 23, 2021.

(51) Int. Cl. G02B 6/38; F16B 21/18; F16L 37/35; F16L 37/56; H01R 13/627

(52) U.S. Cl. CPC G02B 6/387; F16B 21/186; F16L 37/35; F16L 37/56; H01R 13/6278

(57) ABSTRACT

An energy transmitting stud-and-socket releasable fastening system includes a first connection part associated with an energy source and a second connection part with an energy consuming load. When the first and second connection parts are coupled together, energy can be transmitted from the energy source through the stud-and-socket to the load. A core plug in the socket is depressed by the stud as the first and second connection parts are brought together, causing a bolt to deploy which mechanically constrains the stud within the socket. An upstream conduit, running from the energy source and terminating in the core plug, includes an interrupter in the form of a poppet. Energy transmission through the interrupter occurs only when the core plug is in a depressed condition. A push-button actuator disengages the bolt so that the first and second connection parts can be decoupled, and the transfer of energy concurrently terminated.

### CROSS REFERENCE TO RELATED APPLICATIONS

This application claims priority to Provisional Patent Application 63/282,499 filed on Nov. 23, 2021, the entire disclosure of which is hereby incorporated by reference and relied upon.

### BACKGROUND OF THE INVENTION

Field of the Invention. The invention relates generally to a stud-and-socket releasable fastening system, and more particularly to an energy transmitting stud-and-socket releasable fastening system.

Description of Related Art Stud-and-socket releasable fastening systems are well-known in the art. Reference is made to the U.S. Pat. No. 10,247,520 to Manly, issued Apr. 2, 2019, disclosing a robust stud-and-socket type coupling assembly for rapidly connecting and disconnecting an accessory tool to a support structure through a straight-line motion. The assembly comprises a first connection part having a socket in the exemplary form of a tang slot. A core plug is slidably disposed in the socket. A second connection part, in the exemplary form of an accessory tool, includes a stud that has a cross-section configured for mated fit within the socket of the first connection part. A bolt is supported for sliding movement inside the first connection part. The bolt is engageable with the stud of the second connection part in the bolted position to selectively lock together the first and second connection parts.

The stud-and-socket releasable fastening system of U.S. Pat. No. 10,247,520 enables quick and secure mechanical connection between two members for all sorts of applications. There is a need in the art, however, to improve upon the teachings of U.S. Pat. No. 10,247,520 by introducing additional functionality, and hence further expanding the range of applications suitable for stud-and-socket releasable fastening systems.

### BRIEF SUMMARY OF THE INVENTION

The present invention is an energy transmitting stud-and-socket releasable fastening system. The system comprises a first connection part associated with an energy source and a second connection part associated with an energy consuming load. The second connection part is configured to be selectively coupled and decoupled to the first connection part. An upstream conduit has an upstream terminal end disposed in the first connection part. The upstream conduit is configured to transmit energy from the energy source to the upstream terminal end. A downstream conduit has a downstream terminal end disposed in the second connection part. The downstream conduit is configured to transmit energy from the downstream terminal end to the load. A socket is disposed in either the first or second connection part. The socket has an entrance. A core plug is slidably disposed in the socket for movement between extended and depressed conditions. The core plug has a nose end in registry with the entrance of the socket when the core plug is in its extended condition. However, the nose end is recessed inside the socket when the core plug is in the depressed condition. A bolt is supported relative to the socket for movement between set and deployed positions. A stud extends from the other of the first and second connection parts. I.e., in cases where the socket is disposed in the first connection part, the stud extends from the second connection part, and vise-versa. The stud has a distal leading tip configured to displace the core plug away from the entrance of the socket. The stud becomes mechanically constrained within the socket by the bolt when the bolt is moved from its set position to its deployed position. In this manner, the first and second connection parts are securely fastened together. Either the upstream or downstream terminal end is disposed in the stud. The other terminal end is disposed in the core plug and is moveable therewith as the core plug moves between the extended and depressed conditions. I.e., in cases where the upstream terminal end is disposed in the core plug the downstream terminal end is disposed in the stud, and vise-versa. The upstream terminal end operatively couples with the downstream terminal end when the stud is securely constrained within the socket to enable transmission of energy from the upstream conduit to the downstream conduit.

The present invention improves upon the teachings of U.S. Pat. No. 10,247,520 by introducing additional functionality of integrated energy transmission, and hence further expanding the range of applications suitable for stud-and-socket releasable fastening systems. The invention enables the capability of attaching two objects together quickly and securely with an energy transfer enabled therebetween. Locating the upstream and downstream terminal ends in the stud and core plug eliminates or reduces the need to design connections between the upstream and downstream conduits elsewhere on or around the first and second connections parts.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is prior art depiction of a stud-and-socket fastening system taken from the Applicant's own U.S. Pat. No. 10,247,520, wherein the first and second connection parts are shown in a separated, uncoupled disposition;

FIG. 2 is a prior art depiction as in FIG. 1, but with the first and second connection parts shown in a coupled disposition;

FIG. 3 is a highly simplified perspective view of the chief mechanical components of a stud-and-socket fastening system according to one embodiment of the present invention, and with the first and second connection parts shown in a separated, uncoupled disposition;

FIG. 4 is another highly simplified perspective view of the fastening system of FIG. 3, from a slightly anteverted vantage showing the first and second connection parts brought together in preparation for coupling;

FIG. 5 is an elevation view of an exemplary structure constructed of T-slot extrusion members of the type commonly used in industrial applications, wherein four (4) stud-and-socket releasable fastening systems of the present invention are used to enable quick and secure attachment of a lid or cap;

FIG. 6 is a fragmentary perspective view of an exemplary application of the present invention in which a light fixture is poised for connection with a supporting frame to enable the transfer of energy so that the light fixture can be operated;

FIG. 7 is an exemplary schematic electrical diagram of the light fixture embodiment of FIG. 6 showing the connection parts separated;

FIG. 7A is an enlarged view of the region indicated at 7A in FIG. 7;

FIG. 8 is a schematic electrical diagram as in FIG. 7 showing the connection parts operationally connected to enable the transfer of energy to the lighting fixture;

FIG. 8A is an enlarged view of the region indicated at 8A in FIG. 8;

FIG. 9 is a perspective view of an alternative embodiment in which additional upstream and downstream conduits enable applications requiring more electrical and/or light energy transfer than can be accommodated through the socket and stud alone;

FIG. 10 is a perspective view of the alternative embodiment of FIG. 9 as seen from a different vantage;

FIG. 11A-D are a sequence of simplified cross-sectional views of an embodiment of the present invention configured to transfer fluid energy, with the first and second connection parts shown progressively moving from an uncoupled disposition into a fully coupled disposition;

FIG. 12 is a perspective view of an alternative embodiment in which additional upstream and downstream conduits enable applications requiring more fluid energy transfer than can be accommodated through the socket and stud alone;

FIG. 13 is a perspective view of the alternative embodiment of FIG. 12 as seen from a different vantage;

FIG. 14 is a fragmentary perspective view of a still further alternative embodiment in which the first and second connection parts are fitted with a ganged plurality of power-transmitting stud-and-socket coupling systems as applied in the context of an industrial robotic application; and

FIG. 15 is a simplified perspective view of the first and second connection parts of FIG. 14.

### DETAILED DESCRIPTION OF THE INVENTION

The present invention is a stud-and-socket releasable fastening system for mechanically coupling two members, referred to herein generically as a first connection part 20 and a second connection part 22. Reference is again made to U.S. Pat. No. 10,247,520 to Manly, issued Apr. 2, 2019, the entire disclosure of which is hereby incorporated by reference in all permitting jurisdictions. As will be described more fully, the first 20 and second 22 connection parts can be any two members that are required to be quickly and selectively connected to one another, and just as conveniently disconnected.

A socket 24 is disposed in either the first connection part 20 or the second connection part 22. Throughout the following descriptions, the socket 24 will be associated exclusively with the first connection part 20. However, it will be appreciated that the assignment or designation of which connection part 20, 22 is to receive the socket 24 is interchangeable and subject to the designer's choice. The socket 24 has an entrance 26. In the examples, the entrance 26 is formed in a cover plate 27 that is attached to the first connection part, however other designs are possible. The socket 24 is shown having a recessed base 28 spaced from the entrance 26, however it is also contemplated the socket 24 could be bottomless. Moreover, the socket 24 is illustrated throughout as a straight axial formation that establishes a linear path. That is to say, the shaft-like cavity of the socket 24 can be understood as defining an axis centered or generally centered at the entrance 26 and extending along the length of the socket 26 to its recessed base 28. However, it is also contemplated that the socket 24 could, in some configurations, be curved so as to establish an arcuate or spiraling path.

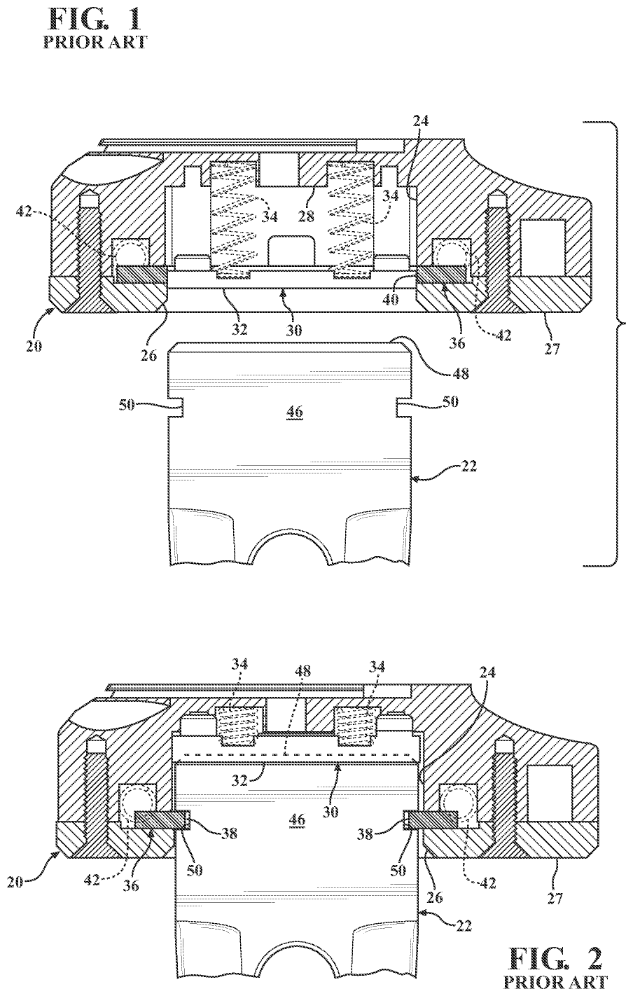

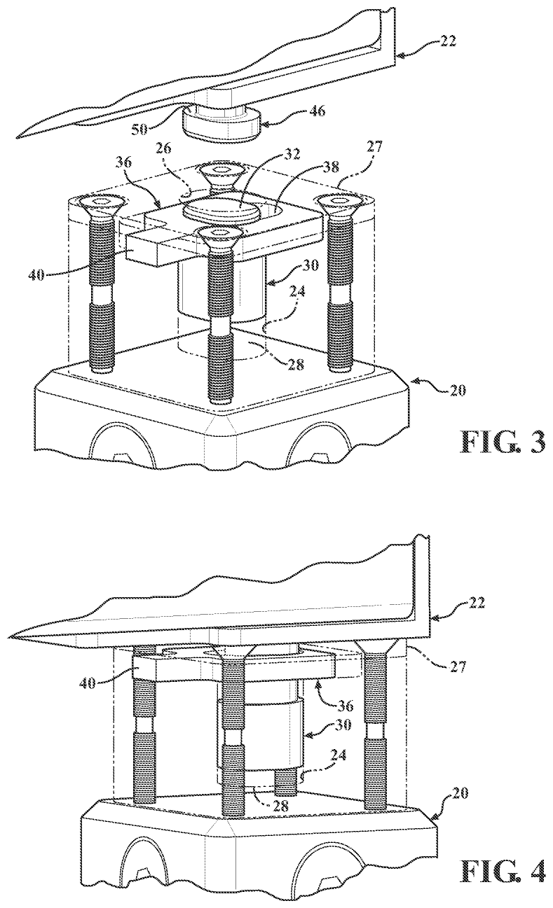

The socket 24 may have any desirable cross-sectional shape, including circular. However circular has the disadvantage of being naturally non-polarized in the sense that its shape alone does not indicate a particular rotational orientation with a mating element. It is therefore desired, but not required, that the socket have a non-circular shape that is nevertheless relatively easy to manufacture. Square shapes are contemplated but are also naturally non-polarized in the sense that its shape permits four (4) rotational orientations with a mating element. Likewise, rectangular shapes are also contemplated as suggested in FIGS. 1 and 2 but are still naturally non-polarized in the sense that a rectangular shape permits two (2) rotational orientations. In the example of FIGS. 3-15, the socket 24 is shown having a generally D-shaped cross-section. A D-shaped cross-section is advantageous in that it is relatively easy to manufacture and offers a fully polarized shape by having only one rotational orientation for a mating element of the same cross-sectional shape. Those of skill in the art will appreciate that cross-sectional shapes other than D-shaped are also possible and readily adaptable for use in the present invention.

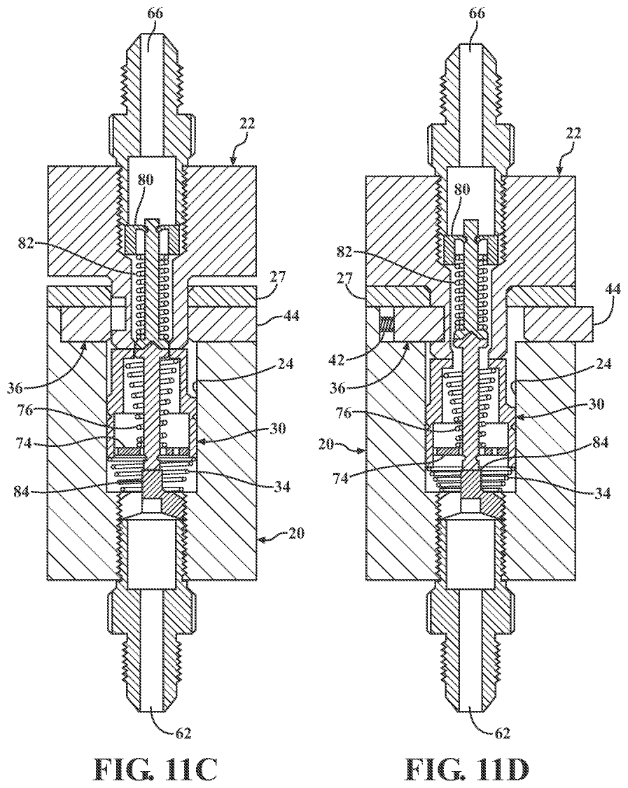

A core plug 30 is disposed in the socket 24 for movement between extended and fully depressed conditions within the socket 24. The core plug 30 may be seen in the extended condition in FIGS. 1, 3, 7, 7A and 11A. The core plug 30 is shown in the fully depressed condition in FIGS. 2, 4, 8, 8A and 11D. The core plug 30 is depicted in intermediate, or transitory, positions between the extreme conditions of extended and fully depressed in FIGS. 11B and 11C. The core plug 30 has a nose end 32 in registry with the entrance 26 of the socket 24 when the core plug 30 is in the extended condition. However, the nose end 32 sinks out of registry with the entrance 26, becoming recessed inside the socket 24, as the core plug 30 moves toward the depressed condition.

One or more core springs 34 are operatively engaged with the core plug 30, so as to urge the core plug 30 toward the extended condition. The core spring 34 is shown in the exemplary forms of a singular coil compression spring in FIGS. 11A-D and a pair of coil compression springs in FIGS. 1, 2, however other forms of biasing devices may be used to urge the core plug 30 toward the extended condition.

A bolt 36 is supported relative to the socket 24 for movement between set and deployed positions. In the illustrated examples where the socket 24 is associated with the first connection part 20, the bolt 36 is likewise supported for movement by, or with respect to, the first connection part 20. FIGS. 1, 3, 4, 7, 7A and 11A depict the bolt 36 in its set position, whereas FIGS. 2 and 11D shown the bolt 36 in the deployed position. The relationship between the bolt 36 and core plug 30 is such that the bolt 36 is only able to move to its deployed position when the core plug 30 is in its fully depressed condition. And its corollary: the core plug 30 is only able to occupy its extended condition in registry with the entrance 26 when the bolt 36 is in its set position. It can perhaps be more descriptively stated that the core plug 30 operates something like a trigger holding the bolt 36 in its set position. When the core plug 30 is displaced a sufficient distance away from the entrance 26, the bolt 36 automatically shifts toward its deployed position.

The bolt 36 can take many different configurations. In some contemplated embodiments, the bolt 36 is a rotary member supported for turning or twisting movement between the set position and the deployed position. In other contemplated embodiments, the bolt 36 is supported for pivotal movement. Indeed, many shapes and motions are possible to accomplish a bolt 36 that is moveable between set and deployed positions. However, in the illustrated examples, the bolt 36 is a plate-like member supported for siding movement relative to the axial extent of the socket 24. That is to say, the bolt 26 is captured in a sliding track in the first connection part 20 just below the cover plate 27 so that it can slide back-and-forth across the socket 24.

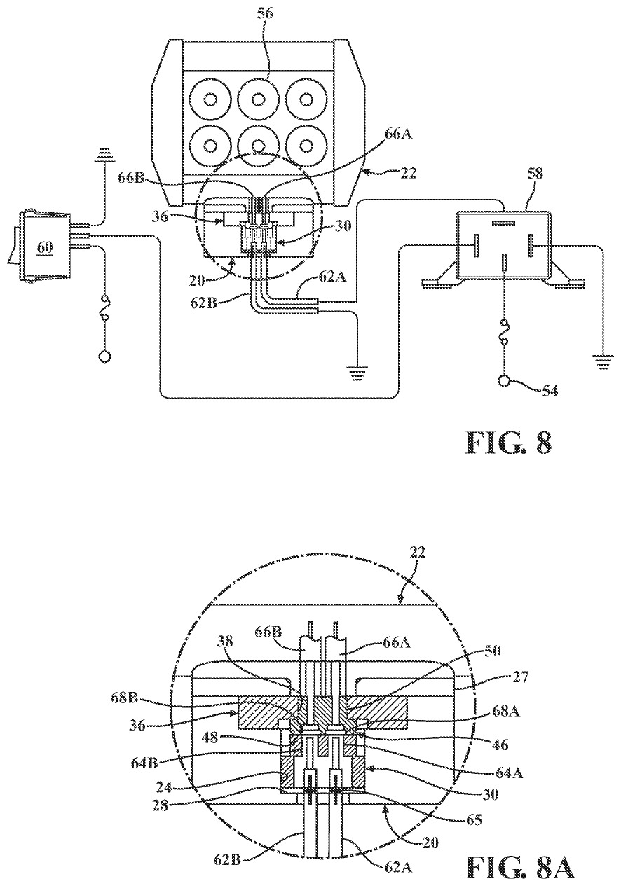

In some contemplated embodiments, the bolt 36 is stationed along only one side of the socket 26. It can be understood that by positioning the bolt 36 along only one side of the socket 26, the bolt 36 can be said to partially surround the socket 24 adjacent its entrance 26. In the illustrated examples, however, the bolt 36 more fully surrounds the socket 26. That is to say, the bolt 36 straddles the socket 26 on opposite sides, which has the effect of increasing structural integrity of the resulting couple with the second connection part 22 as shown in FIGS. 2, 8 and 8A.

The bolt 36 has at least one tooth 38 capable of selectively overlapping the socket 24 when the bolt 36 is in the deployed position. The tooth 38 can take a wide variety of forms. In the accompanying drawings, the tooth 38 is rather simply formed along a peripheral edge (or edges) of the bolt 36. When the bolt 36 is in its deployed position, the tooth 38 passes through a portion of the socket 24. However, when in the set position, no portion of the bolt 36 obstructs the socket 24.

In the example of FIG. 3, the bolt 36 is a generally rectangular body having an open inner region 40 that fully surrounds the socket 24. The shape of the open inner region 40 in FIG. 3 (as well as in FIGS. 4-15) has the appearance of overlapping circles, as suggested by the outline of the number “8,” in which one circle is slightly smaller. Although, in the example of FIGS. 1 and 2, the shape of the open inner region 40 is more elongated, which can be confirmed by reference to the aforementioned U.S. Pat. No. 10,247,520. Indeed, the shape of the open inner region 40 can be modified to suit the intended application.

As previously mentioned, the tooth 38 can be formed along a peripheral edge of the bolt 36. In the illustrated examples where the bolt 25 fully surrounds the socket 26, the one or more teeth 38 are formed within the open inner region 40 of the bolt 36. I.e., the peripheral edges are those along the interior edges of the open inner region 40. The embodiment of FIGS. 1-2 uses opposing teeth 38, whereas the embodiments of FIGS. 3-15 utilize a single tooth 38.

One of more bolt springs 42 are disposed to bias the bolt 36 toward the deployed position. The example of FIGS. 1-2 illustrates the use of two bolt springs 42, whereas the example of FIG. 11D suggests only one bolt spring 42. In both cases, the bolt springs are depicted as being of the coil compression variety, however those of skill in the art will appreciate that any other type of biasing device could be used with appropriate accommodations.

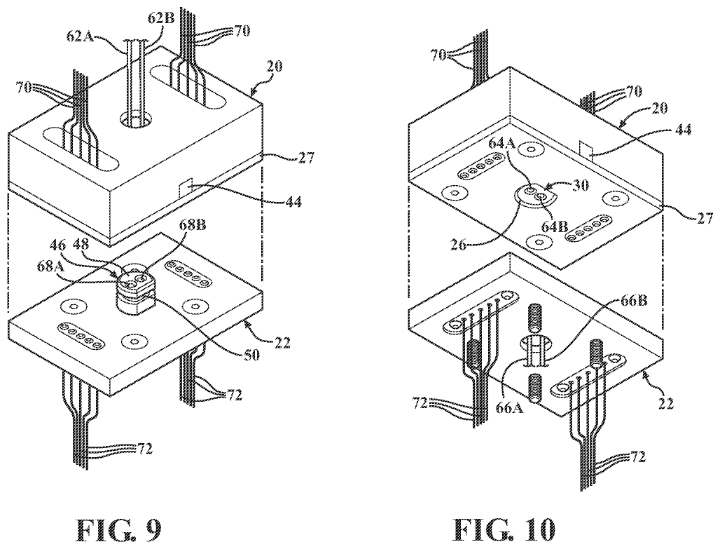

The bolt 36 has an actuator 44 configured to forcibly shift the bolt 36 from the deployed position toward the set position against the bias of the bolt spring 42. The actuator 44 can be a mechanized device separate from the bolt 36, such as a solenoid or stepper motor (not shown). But in the illustrated examples the actuator 44 takes the form of a simple push button extending integrally from the bolt 36, perhaps best seen in FIGS. 3, 4 and 15. By depressing the actuator 44 such as with a thumb or finger, the bolt 36 is moved toward its set position. The size and shape of the actuator 44 can be designed so that when the bolt 36 is in its deployed position the actuator 44 protrudes from the first connection part 20, thus inviting a user to depress it. However, when the bolt 36 is in its set position the actuator 44 is flush with the side of the first connection part 20. This latter condition is well-illustrated in FIGS. 9-11C and 12-13.

As mentioned, the present invention is a stud-and-socket releasable fastening system for mechanically coupling the first connection part 20 with the second connection part 22. These first 20 and second 22 connection parts can be configured for a wide range of uses, a few of which are mentioned herein but many more of which will become apparent to those of skill in the art. The socket 24 is described as being associated with either the first connection part 20 or the second connection part 22, however for convenience the illustrations and descriptions associate the socket 24 exclusively with the first connection part 20. In a corresponding fashion, a stud 46 extends from the other of the first 20 and second 22 connection parts. The stud 46 can be associated with either the first connection part 20 or the second connection part 22, provided it is the complement to the socket 24. For convenience, the illustrations and descriptions associate the stud 46 exclusively with the second connection part 22. It must be understood that the assignment or designation of which connection part 20, 22 is to receive the socket 24 and which to host the stud 46 is interchangeable and subject to the designer's choice.

Generally stated, a primary function of the stud 46 is to become mechanically constrained within the socket 24 so as to effect a mechanical coupling of the first 20 and second 22 connection parts. That is to say, the stud 46 and socket 24 are designed to mate with one another. When the stud 46 is fully seated in the socket 24, the bolt 36 is enabled to move from its set position to its deployed position, which has the effect of trapping the stud 46 in the socket 26. When the stud 46 is thus confined in the socket 26, the first 20 and second 22 connection parts are effectively securely fastened together.

The stud 46 has a cross-sectional shape designed to slide into the socket 24 with a smooth clearance fit. Thus, the cross-sectional shape of the socket 24 will dictate the cross-sectional shape of the stud. In the example of FIGS. 1-2, the stud 46 is rectangular in cross-section. However, in the example of FIGS. 3-15, the stud 46 has a generally D-shaped cross-section configured to mate with the D-shaped cross-section of the socket 24.

The stud 46 has a distal leading tip 48 configured to displace the core plug 30 away from the entrance 26 of the socket 24. As was mentioned, the core plug 30 operates something like a trigger holding the bolt 36 in its set position against the biasing force of the bolt spring 42. As such, the stud 46 can be perceived as the actor that causes the core plug 30 to be displaced from the entrance 26. The point of contact occurs at the distal leading tip 48 of the stud 46. When the core plug 30 is displaced away from the entrance 26, the bolt 36 automatically shifts toward its deployed position. The stud 46 is formed with a catch 50 configured to receive the tooth 38 of the bolt 36 when the bolt 36 is in the deployed condition. The catch 50 can, of course, take on many different configurations as may be dictated by the particular configuration of the tooth 38. In the illustrated examples, the catch 50 takes the form of one or more notches formed in the exterior of the stud 46, axially spaced a sufficient distance from the distal leading tip 48 so as to align with the bolt tooth/teeth 38 when the core plug 30 has been moved to its fully depressed condition.

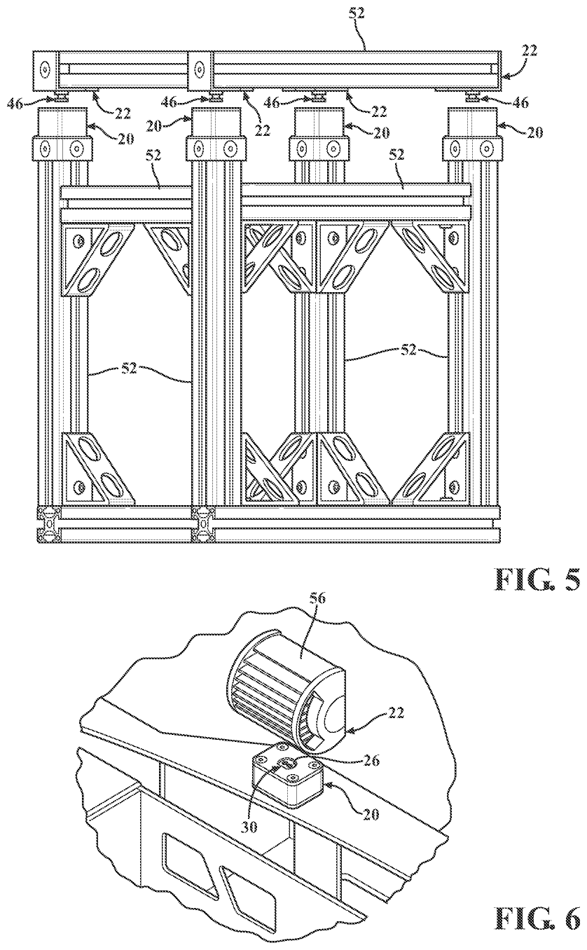

The operation of the mechanical coupling will now be described with reference to the several illustrated examples. In the example of FIGS. 1 and 2, which are taken from U.S. Pat. No. 10,247,520 and thus labeled as prior art, the first connection part 20 is depicted in the form of a universal accessories dock and the second connection part 22 is depicted in the form of an accessory knife blade. To be clear, the dock and knife blade are merely examples of the inventor's own prior art system whose mechanical coupling characteristics are similar to those of the present invention depicted in FIGS. 5-15. Although FIGS. 1 and 2 are prior art depictions, those of skill in the art will appreciate that they are nevertheless instructive and worthy of mention toward understanding the operational characteristics of the present invention, which present invention is an improvement of the embodiment is shown in FIGS. 1 and 2. (The improvement has thus far in the description remained unmentioned, but will be revealed subsequently as the novel integration of energy transmission through the coupling elements.) It is perhaps also helpful to show that the depictions of an accessory knife blade serve to underscore the wide variety of different applications contemplated for the first 20 and second 22 connection parts of this present invention, albeit with the addition of the improvement features to be subsequently discussed. Therefore, FIGS. 1 and 2 are described here in detail for their value in expositing the mechanical coupling characteristics. A person of ordinary skill in the art could modify the embodiment of FIGS. 1 and 2 to include the improvement features of this invention.

Continuing with FIGS. 1-2, the first connection part 20 has a cover plate 27 in which is formed an entrance 26 to a cavity-like socket 24. The entrance 26 is preferably surrounded by funnel-like tapers or generous chamfers that facilitate the coupling process. A core plug 30 is slidably disposed in the socket 24. The core plug 30 has a peripheral shape that is generally equal to the peripheral shape of the stud 46 so that both slide with somewhat equal smoothness in the socket 24. When the first connection part 20 is not coupled to the second connection part 22, a nose end 32 of the core plug 30 is located in the entrance 26 (FIG. 1). In this position, the nose end 32 acts like a stopper to prevent debris from entering the socket 24. At least one core spring 34 is operatively disposed in bias against the core plug 30. In the illustrated embodiment, a pair of core springs 34 are operatively disposed in the socket 24 and biased against the core plug 30. The core plug 30 is shown having stop tabs that ride up and down in tab tracks formed in the socket 24. The stop tabs position the nose end 32 of the core plug 30 flush with or slightly recessed at the entrance 26. Spring seats may be formed in the core plug 30 to help maintain position of the core springs 34.

A bolt 36 is operatively disposed in the first connection part 20 for selective movement between set and deployed positions. The bolt 36 includes at least one, but preferably two, teeth 38 formed within the interior confines of an open inner region 40. In the set position, the first connection part 20 is disconnected from the second connection part 22 as in FIG. 1. The bolt 36 is supported on slide tracks within the first connection part 20 for movement transverse to the path of the socket 24. A pair of compression-type bolt springs 42 push directly against the bolt 36. An actuator 44 extends from the bolt 36. When the user presses on the actuator 44, the bolt 36 slides against the bolt springs 42 in movement toward its deployed position.

A stud 46 extends from the second connection part 22 which, although shown as a knife blade, could be any suitable thing or object. The stud 46 has a pair of notch-like catches 50 configured to interact with the bolt teeth 38. The entrance 26 and socket 24 are both shaped to receive the stud 46 with an easy sliding fit but with relatively little free play so that the second connection part 22 is not perceived to wiggle when connected to the first connection part 20.

FIG. 1 shows the stud 46 before it enters the socket 24, whereas FIG. 2 shows the stud 46 fully seated in the socket 24 with the first 20 and second 22 connection parts securely coupled together. During the coupling process, a distal leading tip 48 of the stud 46 is guided to the entrance 26 of the socket 24 where it immediately encounters the nose end 32 of the core plug 30. The nose end 32 of the core plug 30 may be formed with a concavity that receives a chamfered or rounded distal leading tip 48 of the stud 46 in self-centering fashion. With continued insertion of the stud 46, the core plug 30 is pushed ahead and deeper into the socket 24 compressing the core spring 34. The core plug 30 pushes up through the open inner region 40 of the bolt 36, followed immediately be the stud 46 in a smooth continuous motion. When the catches 50 in the stud 46 align with the bolt teeth 38, the bolt 36 automatically slides toward its deployed position under the influence of the bolt springs 42. The teeth 38 seated in the catches 50 effectively trap the stud 46 in the socket 24 and couple the first 20 and second 22 connection parts together, as depicted in FIG. 2.

In order to decouple the first 20 and second 22 connection parts from one another, the user depresses the actuator 44 (not visible in FIG. 1 or 2), which has the effect of shifting the teeth 38 out of register with the catches 50 and allowing the stud 46 to be withdrawn. As the stud 46 is withdrawn from the socket 24, the pressure of the core springs 34 assists with a light pushing action to eject the first connection part 20. Because the core plug 30 has a peripheral shape that is matched to the peripheral shape of the stud 46, the nose end 32 of the core plug 30 follows the stud 46 as it freely passes through the bolt 36 and into the entrance 26 in the bottom plate 76. The stud 46 is withdrawn completely from the first connection part 20, but the core plug 30 is mechanically arrested at the entrance 26 in its extended condition holding the bolt 36 in its set position. That is to say, as the first connection part 20 uncouples from the first connection part 20, the core plug 30 automatically seats itself inside the open inner region 40 of the bolt 36. The core plug 30 thus effectively jams itself in the bolt 36, holding the bolt springs 42 compressed, and continues to restrain the bolt 36 in this set condition until the stud 46 is re-inserted.

FIGS. 3 and 4 shown embodiments of the first 20 and second 22 connection parts in a different configuration and from differing perspectives. For example, the embodiment of FIGS. 3 and 4 could be perceived as connection points for a structure fabricated from T-slot extrusion members 52 like that depicted in FIG. 5. That is to say, one contemplated application of the present invention is within an industrial setting where useful structures can be quickly and securely erected from using a network of T-slot extrusion members 52. For simplicity, FIGS. 3 and 4 show only the core plug 30 and bolt 36 components of the first connection part 20, and the stud 46 of the second connection part. Considering the exemplary box-like base structure in FIG. 5 assembled from commercially available T-slot extrusion members 52, four (4) stud-and-socket releasable fastening systems of the present invention are used to enable quick and secure attachment of a lid or cap. In the illustrated configuration of FIG. 5, the box-like base structure represents the first connection part 20 and lid or cap represents the second connection part 22.

As alluded to, the present invention improves upon known stud-and-socket type connection systems by the novel integration of energy transmission through the coupling elements. In particular, when the first connection part 20 is associated with an energy source 54 and the second connection part 22 associated with an energy consuming load 56, coupling of the first 20 and second 22 connection parts will automatically and concurrently effectuate energy transmission from the energy source 54 to the energy consuming load 56. The energy transmitted through the stud-and-socket type connection system of this invention can be of any type and used for any purpose including for the delivery of power and/or communication signals. Exemplary forms of energy include, but are not limited to, electricity, fluids (hydraulics and pneumatics) and light, and well as mechanical motion. There is no intent to limit the forms or types of energy that can be transmitted through the first 20 and second 22 connection parts of this invention.

The example of FIG. 6 is of a detachable lighting fixture, such as could be found on an off-road or utility vehicle. This context is offered for illustrative purposes only, considering that a person of skill in the art will be informed by this example to envision other possible applications. The first connection part 20 is fixed to the vehicle frame or body whereas the second connection part 22 is the body of the lighting fixture.

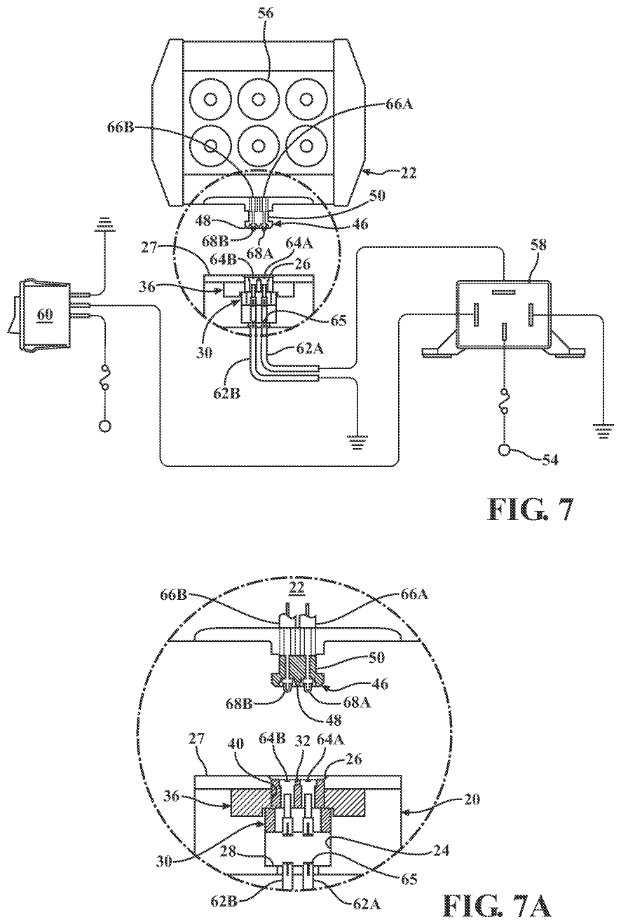

FIGS. 7-8A represent schematic illustrations in support of the electrical lighting example of FIG. 6. The first connection part 20 is associated with the energy source 54 which could be a standard vehicular 6- or 12-volt battery. In another context easily imagined, the energy source 54 for a lighting fixture could be voltage supplied from a standard AC line or from a low-voltage transformer. Of course, many options are possible. FIGS. 7 and 8 show a lead from the energy source 54 operatively connected to a first terminal of a basic relay 58. A second terminal of the relay 58 is operatively connected to a switch 60. A third terminal of the relay 58 is operatively connected to the first connection part 20. And a fourth terminal of the relay 58 is operatively connected to electrical ground.

The first connection part 20 has at least one upstream conduit 62 configured to transmit energy from the energy source 54 to an upstream terminal end 64. In instances where the energy source 54 is electrical energy, the upstream conduit 62 is an electrically conductive wire or element. In the case of FIGS. 7-8A, two upstream conduits 62A, 62B are shown, each having a respective upstream terminal end 64A, 64B. The previously mentioned lead from the energy source 54 to the first terminal of the relay 58 corresponds with the upstream conduit 62A. The downstream conduit 62B is operatively connected to electrical ground in this example. In some contemplated embodiments, the first connection part 20 can be configured with more than two upstream conduits 62A.B . . . n, each having a respective upstream terminal end 64A,B . . . n.

The upstream terminal ends 64A, 64B are disposed in the core plug 30 and are moveable therewith as the core plug 30 moves between the extended and depressed conditions. This can be appreciated by comparing FIGS. 7A and 8A, where FIG. 7A has the core plug 30 in the extended condition and in the depressed condition for FIG. 8A.

In the illustrated examples of FIGS. 7-8A, the upstream conduit 62 includes a switch-like interrupter feature 65 associated with each of the upstream terminal ends 64A, 64B. The interrupter 65 has an open condition that effectively prohibits energy from reaching the upstream terminal ends 64A, 64B when the core plug 30 is in the extended condition. However, when the core plug 30 is in is fully depressed condition, the interrupter 65 closes enabling the transmission of energy to the upstream terminal ends 64A, 64B. This can be understood as a safety feature, in which the bare exposed upstream terminal ends 64A, 64B will be prevented from giving an inadvertent electrical shock when the second connection part 22 is not in place. The interrupter 65 feature is clearly seen in FIGS. 7A and 8A comprising a variable gap or spacing between the core plug 30 and the upstream conduits 62A, 62B. It may be helpful to understand the interrupter 65 and being in the functional form of a poppet valve, in that the components cycle up and down (or back-and-forth) between open and closed conditions.

The second connection part 22 likewise has at least one downstream conduit 66 configured to transmit energy to the energy consuming load 56 from a downstream terminal end 68 disposed in the stud 46. In instances where the energy source 54 is electrical energy, the downstream conduit 66 is an electrically conductive wire or element. In the case of FIGS. 7-8A, two downstream conduits 66A, 66B are shown, each having a respective downstream terminal end 68A, 68B.

The upstream terminal ends 64A, 64B are aligned for engagement with the downstream terminal ends 68A, 68B when the distal leading tip 48 of the stud 46 depresses the core plug 30 away from the socket entrance 26. That is to say, the upstream terminal ends 64A, 64B operatively couple with the downstream terminal ends 68A, 68B when the stud 46 is securely constrained within the socket 24. The upstream terminal ends 64A, 64B may be configured with locater profiles, and likewise the downstream terminal ends 68A, 68B with complementary profiles adapted to self-center with one another upon direct engagement. The upstream 64A, 64B and 68A, 68B downstream terminal ends can be fashioned from commercially available spring-loaded contacts, such as those offered by MILL-MAX Mfg. Corp. (New York, USA).

Coupling of the second connection part 22 to the first connection part 20 in the manner previously described causes the core plug 30 to descend in the socket 24. Upon nearing its fully depressed condition, the interior portions of upstream terminal ends 64A, 64B come into electrical contact with their respective upstream conduits 62A, 62B, thus closing the electrical circuit and allowing energy to flow to the lighting fixture (subject to operator control of the switch 60). This is perhaps best shown in FIG. 8A where the upstream terminal ends 64A, 64B can be seen in direct contact with the downstream terminal ends 68A, 68B thus enabling transmission of energy from the upstream conduit 62 to the downstream conduit. As a consequence, the light fixture (the load) can be made operable at will by the user, via the switch 60. At any time the user wishes to remove or replace the light fixture 22, the bolt 36 is actuated (via actuator 44), enabling decoupling of the first 20 and second 22 connection parts.

Although a singular light fixture is described in connection with the example of FIGS. 6-8A, those of skill in the art will envision this invention applied in many other ways even within the limited context of powered vehicular systems. Taking inspiration from FIG. 5, one can easily imagine a vehicular application in which an entire lightbar system is quickly and securely connected/disconnected from a vehicle. In another example, the electrical power transmitting stud-and socket system of this invention is used to quickly and securely connect a sound, navigation and/or computer system in a land or marine vehicle. The fleet trucking and law enforcement markets are examples of two fields of use in which specialized systems may be required to frequently plug in and out of use. Applications in the competitive environment of robotics competitions can be easily envisioned. The electrical power transmitting stud-and socket system can be deployed to rapidly replace broken elements or attach different kinds of mechanized features during a competition. Thinking outside of vehicular contexts, the electrical power transmitting stud-and socket system of this invention could be used attach accessory lights in a home or building. In industry, power driven accessories like fans and heaters (to name only two) can be quickly and securely attached when needed and just as quickly detached when the need is passed. Indeed, the applications of this invention to transmit electrical energy through a stud-and socket coupling system are seemingly limitless.

Although the example of FIGS. 6-8A portray the transmission of electrical energy, those of skill in the art will be able to envision a similar system modified to transmit light energy. That is, if the energy source 54 is light energy, such as in a fiber optic system, the upstream 62A,B . . . n and downstream upstream conduits 66A,B . . . n conduits could be fabricated as light transmissive wave guides, e.g., fiber-optic cables. In applications requiring data transmission, the stud-and socket system of this invention could be used to quickly and securely connect the signal source 54 to a signal receiver 56.

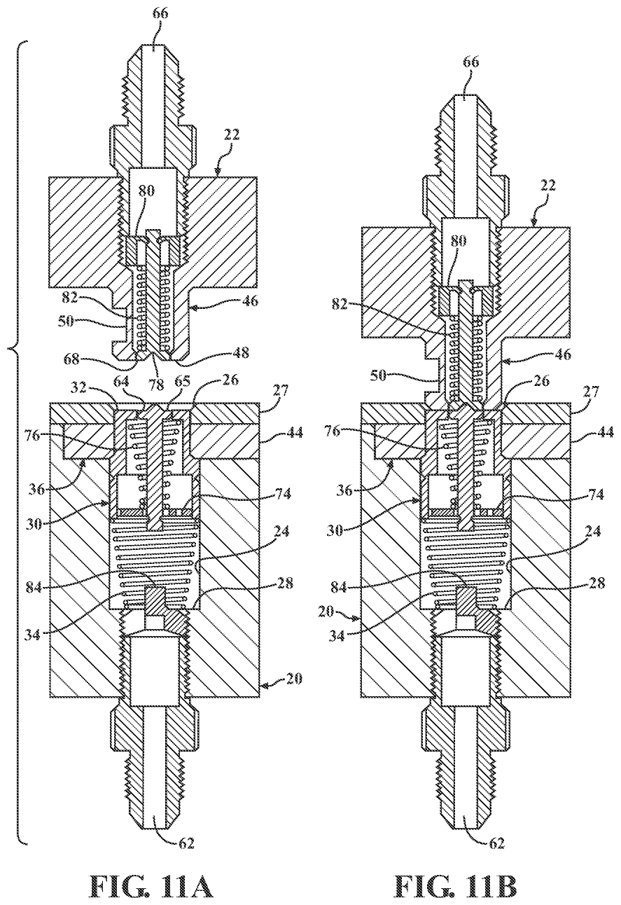

FIGS. 9 and 10 represent extensions of the aforementioned electrical energy and light energy transmitting modes. In this example, additional upstream conduits 70 are supported in the first connection part 20 but do not pass through the socket 24 or core plug 30. Likewise additional downstream conduits 72 are supported in the second connection part 22 but do not pass through the stud 46. These additional conduits 70, 72 are aligned so as to make respectively operative, power-transmitting connections when the first 20 and second 22 connections parts are coupled via the stud-and socket system of this invention. Thus, in applications requiring more discrete electrical or light signals than can be accommodated through the socket 24 and stud 46, this embodiment offers a convenient solution without sacrificing connection speed or structural integrity. The terminal ends of the additional conduits 70, 72 can be fashioned from commercially available spring-loaded contacts, such as those offered by MILL-MAX Mfg. Corp. (New York, USA).

As mentioned, the stud-and socket system of this invention can be configured to accommodate the transmission of fluid as the type of energy produced by the energy source 54. Perhaps the most common types of fluid energy are hydraulics (liquids) and pneumatics (gasses). Reference is made to FIGS. 11A-D, where the first connection part 20 is somewhat arbitrarily designated as the lower part and the second connection part 22 as the upper part to maintain continuity with the respective socket 24 and stud 46 associations. It will be appreciated that, without departing from the spirit of this invention, the first connection part 20 could be designated as the upper part associated with the stud 46 and the second connection part 22 as the lower part associated with the socket 24. This interchangeability of the socket 24 and stud 46 vis-à-vis the first 20 and second 22 connection parts is applicable throughout the several embodiments.

Returning again to FIGS. 11A-D, the upstream 62 and downstream 66 conduits here comprise fluid conductive lines or hoses. For purposes of this illustration, the fluid transmitted can either be hydraulic or pneumatic. The upstream conduit 62 has an upstream terminal end 64 and the downstream conduit 66 has a downstream terminal end 68. Comparisons to the electrical example of FIGS. 7-8A should be apparent to those of skill in the art. And as in the electrical example, the upstream conduit 62 includes an interrupter 65 feature associated with the upstream terminal end 64. Given the fluidic nature of energy, it is perhaps more appropriate to classify the interrupter 65 here as a sort valve instead of a switch.

The interrupter 65 has an open condition that effectively prohibits fluid energy from reaching the upstream terminal end 64 when the core plug 30 is in the extended condition. However, when the core plug 30 is in is fully depressed condition, the interrupter 65 closes enabling the transmission of fluid energy to the upstream terminal end 64. The interrupter 65 feature can be perceived quite easily here as a poppet valve. The head of this poppet valve carries the previously mentioned locator feature, in the form of a small convex spike, that aides in self-centering with the stud 46. In this exemplary embodiment, the interrupter 65 is fitted with a disc-like keeper 74 that is captured inside a skirt-like recess in the core plug 30. A backing spring 76 is also located inside a skirt-like recess, pressed between the keeper 74 and the underside of the core plug 30.

The stud 46 also includes a safety valve 78 integrated with its downstream terminal end 68. The safety vale 78 shown in this example is of the poppet type having a head formed with a dimpled or concave locator feature to complement the convex feature on the head of the interrupter 65. A flow-through retainer 80 is captured in the second connection part 22 to help hold a stem of the safety valve 78 in position. A safety spring 82 is located inside the stud 46 and presses between the retainer 80 and the head of the safety valve 78.

FIGS. 11A-D represent a sequence or progression of movement in which the first 20 and second 22 connection parts are brought together from an uncoupled state to a securely coupled state enabling fluid transmission therebetween. In FIG. 11A, the first 20 and second 22 connection parts completely separated from one another. Fluid energy is unable to flow from the upstream conduit 62 to the downstream conduit 66. In FIG. 11B, the first 20 and second 22 connection parts are brought together so that the distal leading tip 48 of the stud 46 makes initial contact with the nose end 32 of the core plug 30. The components self-align with one another via the locator features on the opposing heads of the interrupter 65 and safety valve 78. Still, fluid energy is unable to flow from the upstream conduit 62 to the downstream conduit 66.

In FIG. 11C, the first connection part 20 is being pressed against the second connection part 22, as can be seen by the stud 46 descending into the socket 24. Although the core plug 30 is fully below the bolt 36, the bolt 36 remains in its set position because the stud catch 50 has not yet aligned with the bolt tooth 38. Although the lower end of the shaft of the interrupter 65 has just made initial contact with an upstanding nub 84 at the base 28 of the socket 24, neither the interrupter 65 nor the safety valve 78 have shifted from their respective positions sealing the ends of the upstream 64 and downstream 68 terminal ends. As such, even at this advanced state, fluid energy is still unable to flow from the upstream conduit 62 to the downstream conduit 66.

In FIG. 11D, the first connection part 20 has been pressed in full contact against the second connection part 22. The core plug 30 has reached its fully depressed condition. The stud catch 50 has moved into registry with the bolt tooth 38, enabling the spring-backed bolt 36 to shift rightward trapping the stud 46 in the socket 24. The lower end of the shaft of the interrupter 65 has remained in abutment with the nub 84 while the core plug 30 has continued to descend in the socket 24. This has caused the head of the interrupter 65 to rise above the nose end 32 of the core plug 30, which in turn has pushed the head of the safety valve 78 inside the downstream terminal end 68 thereby creating a flow path for fluid energy from the upstream conduit 62 into the downstream conduit 66. Those of skill in the art will be able to appreciate from FIG. 11D that pressurized hydraulic or pneumatic fluid will be able to flow from the upstream conduit 62, around the nub 84, through the core spring 34 and keeper 74, into the skirt-like recess of the core plug 30, around the head of the interrupter 65, into the hole in the distal leading tip 48, around the head of the safety valve 78, through its safety spring 82 and retainer 80, and into the downstream conduit 66 where it is eventually routed to an energy consuming load 56.

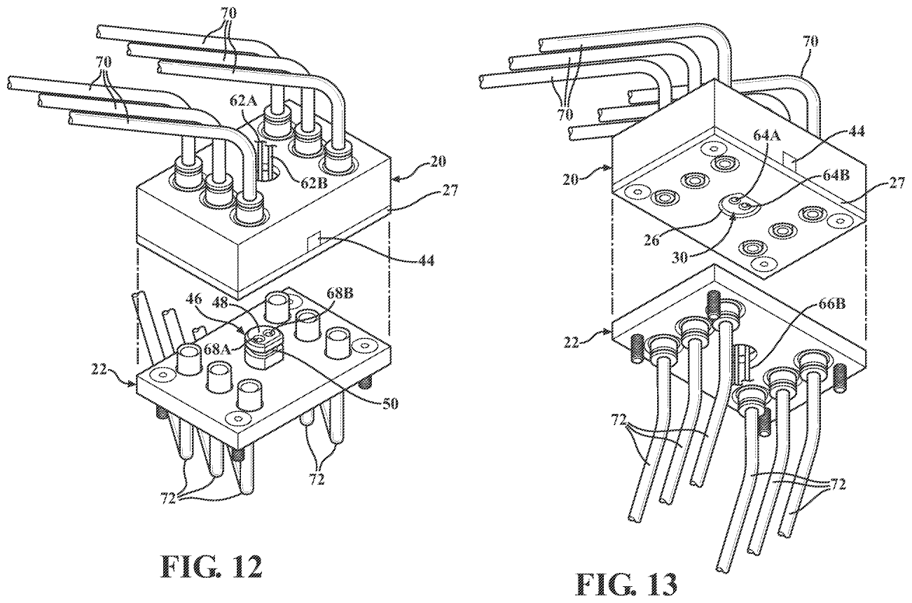

FIGS. 12 and 13 may be likened to FIGS. 9 and 10, in that additional upstream conduits 70 are supported in the first connection part 20 but do not pass through the socket 24 or core plug 30, and additional downstream conduits 72 are supported in the second connection part 222 but do not pass through the stud 46. These additional conduits 70, 72 are aligned so as to make respectively operative, fluid power-transmitting connections when the first 20 and second 22 connections parts are coupled via the stud-and socket system of this invention. Thus, in applications requiring more hydraulic or pneumatic connections than can be accommodated through the socket 24 and stud 46, this embodiment offers a convenient solution without sacrificing connection speed or structural integrity.

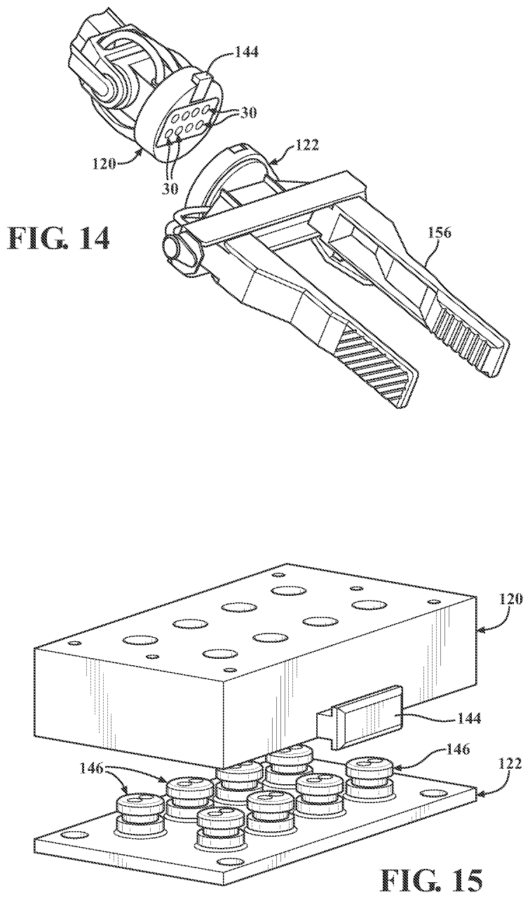

FIGS. 14 and 15 offer yet another alternative embodiment in which the first 120 and second 122 connection parts may be fitted with a ganged plurality of power-transmitting stud-and-socket coupling systems of the type mentioned. In this example, which by FIG. 14 can be seen as suggestive of an industrial robotic application, the first connection part 120 is fitted with a gang of eight (8) sockets 124, and the second connection part 122 a corresponding gang of eight studs 146. Each stud 146 is shown in an exemplary fashion in FIG. 15 containing two downstream terminal ends 168, as in the example of FIGS. 7-10. Although the FIGS. 7-10 portray embodiments in which the form of energy transmitted is electricity or light, those of skill in the art will appreciate that the embodiment of FIGS. 14 and 15 could be configured to transfer other forms of energy, including but not limited to pneumatic and hydraulic.

Slidably supported within the first connection part 120 is a single bolt fitted with eight open interior regions, neither of which are visible in FIGS. 14-15. Notwithstanding the lack of illustration, it will be apparent that one bolt can be configured to interact concurrently with all eight studs 146, thus creating a coupling between the first 120 and second 122 connection parts of eight-fold strength with the capability of eight-fold energy transmission. Naturally, it can be envisioned that if a particular application required a coupling with say eight-fold strength but say only two-fold energy transmission, then six of eight studs 146 could be configured without energy transfer capability, much like those depicted in FIGS. 3 and 4. Decoupling of the first 120 and second 122 connection parts is accomplished with a common push-button actuator 144. By depressing the common actuator 144, the single bolt is moved toward its set position such that its teeth disengage from the respective catch on each stud 146 in a concerted manner. As the studs 146 retract, a core plug (not shown) in each socket 124 moves toward its respective extended condition at the socket entrance, just as previously described.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. An energy transmitting stud-and-socket releasable fastening system comprising:
a first connection part associated with an energy source, an upstream conduit having an upstream terminal end disposed in said first connection part, said upstream conduit configured to transmit energy from the energy source to said upstream terminal end,
a second connection part associated with an energy consuming load, said second connection part configured to be selectively coupled and decoupled to said first connection part, a downstream conduit having a downstream terminal end disposed in said second connection part, said downstream conduit configured to transmit energy from said downstream terminal end to the load,
a socket disposed in one of said first and second connection parts, said socket having an entrance, a core plug slidably disposed in said socket for movement between extended and depressed conditions, said core plug having a nose end in registry with said entrance of said socket when said core plug is in said extended condition and recessed inside said socket when said core plug is in said depressed condition, a bolt supported relative to said socket for movement between set and deployed positions, wherein said core plug in said extended condition directly holds said bolt in said set position,
a stud extending from the other of said first and second connection parts, said stud having a distal leading tip configured to displace said core plug away from said entrance of said socket, said stud becoming mechanically constrained within said socket by said bolt when moved from said set position to said deployed position to securely fasten together said first and second connection parts,
one of said upstream and downstream terminal ends disposed in said stud, the other of said upstream and downstream terminal ends disposed in said core plug and moveable therewith as said core plug moves between said extended and depressed conditions, wherein said upstream terminal end operatively couples with said downstream terminal end when said stud is securely constrained within said socket to enable transmission of energy from said upstream conduit through said core plug to said downstream conduit.

2. The system of claim 1 wherein said upstream terminal end is disposed in said core plug and moveable therewith as said core plug moves between said extended and depressed conditions, said upstream conduit including an interrupter adjacent said upstream terminal end.

3. The system of claim 2 wherein said interrupter comprises a poppet having an open condition prohibiting the transmission of energy to said upstream terminal end when said core plug is in said depressed condition, said interrupter having a closed condition enabling the transmission of energy to said upstream terminal end when said core plug is in said extended condition.

4. The system of claim 3 wherein said poppet has a backing spring.

5. The system of claim 1 wherein said upstream terminal end aligns with said downstream terminal end when said distal leading tip depresses said core plug away from said socket entrance.

6. The system of claim 1 wherein the energy source is electrical energy, said upstream and downstream conduits comprising electrically conductive wires.

7. The system of claim 1 wherein the energy source is fluid energy, said upstream and downstream conduits comprising fluid conductive lines.

8. The system of claim 1 wherein the energy source is light energy, said upstream and downstream conduits comprising light transmissive wave guides.

9. The system of claim 1 wherein said socket has a generally D-shaped cross-section, said stud having a generally D-shaped cross-section configured to mate with said D-shaped cross-section of said socket.

10. An energy transmitting stud-and-socket releasable fastening system comprising:
a first connection part associated with an energy source, an upstream conduit having an upstream terminal end disposed in said first connection part, said upstream conduit configured to transmit energy from the energy source to said upstream terminal end,
a second connection part associated with an energy consuming load, said second connection part configured to be selectively coupled and decoupled to said first connection part, a downstream conduit having a downstream terminal end disposed in said second connection part, said downstream conduit configured to transmit energy from said downstream terminal end to the load,
a socket disposed in said first connection part, said socket having an entrance, a core plug slidably disposed in said socket for movement between extended and depressed conditions, said core plug having a nose end in registry with said entrance of said socket when said core plug is in said extended condition and recessed inside said socket when said core plug is in said depressed condition, a bolt supported relative to said socket for movement between set and deployed positions, wherein said core plug in said extended condition directly holds said bolt in said set position, said upstream terminal end disposed in said core plug and moveable therewith as said core plug moves between said extended and depressed conditions,
a stud extending from said second connection part, said stud having a distal leading tip configured to displace said core plug away from said entrance of said socket, said stud becoming mechanically constrained within said socket by said bolt when moved from said set position to said deployed position to securely fasten together said first and second connection parts, said downstream terminal end disposed in said stud,
wherein said upstream terminal end operatively couples with said downstream terminal end when said stud is securely constrained within said socket to enable transmission of energy from said upstream conduit through said core plug to said downstream conduit.

11. The system of claim 10 wherein said upstream conduit includes an interrupter adjacent said upstream terminal end.

12. The system of claim 11 wherein said interrupter comprises a poppet having an open condition prohibiting the transmission of energy to said upstream terminal end when said core plug is in said depressed condition, said interrupter having a closed condition enabling the transmission of energy to said upstream terminal end when said core plug is in said extended condition.

13. The system of claim 12 wherein said poppet has a backing spring.

14. The system of claim 10 wherein said upstream terminal end aligns with said downstream terminal end when said distal leading tip depresses said core plug away from said socket entrance.

15. The system of claim 10 wherein the energy source is electrical energy, said upstream and downstream conduits comprising electrically conductive wires.

16. The system of claim 10 wherein the energy source is fluid energy, said upstream and downstream conduits comprising fluid conductive lines.

17. The system of claim 10 wherein the energy source is light energy, said upstream and downstream conduits comprising light transmissive wave guides.

18. An energy transmitting stud-and-socket releasable fastening system comprising:
a first connection part associated with an energy source, an upstream conduit having an upstream terminal end disposed in said first connection part, said upstream conduit configured to transmit energy from the energy source to said upstream terminal end, said upstream conduit including an interrupter adjacent said upstream terminal end, said interrupter having an open condition prohibiting the transmission of energy to said upstream terminal end and a closed condition enabling the transmission of energy to said upstream terminal end,
a second connection part associated with an energy consuming load, said second connection part configured to be selectively coupled and decoupled to said first connection part, a downstream conduit having a downstream terminal end disposed in said second connection part, said downstream conduit configured to transmit energy from said downstream terminal end to the load,
a socket disposed in said first connection part, said socket having an entrance, a core plug slidably disposed in said socket for movement between extended and depressed conditions, said core plug having a nose end in registry with said entrance of said socket when said core plug is in said extended condition and recessed inside said socket when said core plug is in said depressed condition, a bolt supported relative to said socket for movement between set and deployed positions, wherein said core plug in said extended condition directly holds said bolt in said set position, said upstream terminal end disposed in said core plug and moveable therewith as said core plug moves between said extended and depressed conditions,
a stud extending from said second connection part, said stud having a distal leading tip configured to displace said core plug away from said entrance of said socket, said stud becoming mechanically constrained within said socket by said bolt when moved from said set position to said deployed position to securely fasten together said first and second connection parts, said downstream terminal end disposed in said stud,
wherein said upstream terminal end operatively couples with said downstream terminal end when said stud is securely constrained within said socket to enable transmission of energy through said interrupter and through said core plug when said core plug is in said depressed condition.

19. The system of claim 18 wherein said upstream and downstream conduits are selected from the group consisting essentially of electrically conductive wires, fluid conductive lines and light transmissive wave guides.

20. The system of claim 19 wherein said interrupter comprises a poppet having an open condition prohibiting the transmission of energy to said upstream terminal end when said core plug is in said depressed condition, said interrupter having a closed condition enabling the transmission of energy to said upstream terminal end when said core plug is in said extended condition.
